(19) United States
(12) Patent Application Publication
(10) Pub. No.: US 2007/0300303 A1
(43) Pub. Date: Dec. 27, 2007

(54) Method and system for removing pestware from a computer

(76) Inventors: Michael P. Greene, Boulder, CO (US); Paul Piccard, Longmont, CO (US); Michael Stieber, Boulder, CO (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/472,232

(22) Filed: Jun. 21, 2006

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

A method and system for removing pestware from a computer is described. One illustrative embodiment detects that pestware is present on a computer, automatically suspends connectivity of the computer with a network, and removes the pestware from the computer while the connectivity of the computer with the network is suspended. This prevents the pestware from downloading additional pestware from the network in response to a removal attempt.

### FIELD OF THE INVENTION

The present invention relates generally to protecting computers from malware or pestware. In particular, but not by way of limitation, the present invention relates to methods and systems for removing malware or pestware from a computer.

### BACKGROUND OF THE INVENTION

Protecting personal computers against a never-ending onslaught of “pestware” such as viruses, Trojan horses, spyware, adware, and downloaders on personal computers has become vitally important to computer users. Some pestware is merely annoying to the user or degrades system performance. Other pestware is highly malicious. Many computer users depend on anti-pestware software that attempts to detect and remove pestware automatically. Anti-pestware software typically scans running processes in memory and files contained on storage devices such as disk drives, comparing them, at expected locations, against a set of “signatures” that identify specific, known types of pestware.

The Internet provides a channel through which pestware can be distributed to a large number of computers, resulting in inconvenience, lost productivity, and sometimes damage to valuable data. Once a computer that is connected to the Internet has suffered a pestware attack, removing the pestware from the computer can be difficult. Some types of pestware are designed to protect themselves by downloading pestware files from the Internet if an attempt is made to delete the pestware. For example, some pestware is made up of multiple components that “watch out for one another.” When one component is deleted, another component of the pestware downloads a replacement pestware file (or other pestware) from the Internet. Conventional anti-pestware software does not deal effectively with pestware that downloads pestware from a network in response to an attempt to remove the pestware.

It is thus apparent that there is a need in the art for an improved method and system for removing pestware from a computer.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and system for removing pestware from a computer. One illustrative embodiment is a method, comprising detecting that pestware is present on the computer; automatically suspending connectivity of the computer with a network; and removing the pestware from the computer while the connectivity of the computer with the network is suspended.

Another illustrative embodiment is a system for protecting a computer from pestware, comprising a detection module configured to detect that pestware is present on the computer; a network connectivity control module configured to suspend connectivity of the computer with a network automatically when the detection module has detected that pestware is present on the computer; and a removal module configured to remove the pestware from the computer while the connectivity of the computer with the network is suspended. These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a functional block diagram of a computer equipped with an anti-pestware system in accordance with an illustrative embodiment of the invention;

FIG. 2 is a flowchart of a method for removing pestware from a computer in accordance with an illustrative embodiment of the invention; and

FIG. 3 is a flowchart of a method for removing pestware from a computer in accordance with another illustrative embodiment of the invention.

### DETAILED DESCRIPTION

“Pestware,” as used herein, refers to any program that damages or disrupts a computer system or that collects or reports information about a person or an organization. Examples include, without limitation, viruses, worms, Trojan horses, spyware, adware, and downloaders.

In an illustrative embodiment of the invention, pestware is detected on a computer. Before the pestware is removed from the computer, the connectivity of the computer with a network is automatically suspended. While connectivity with the network is suspended, the pestware is removed from the computer. This prevents the pestware from downloading additional pestware from the Internet or other network during the removal process.

The network can be the Internet, a private intranet, or other network. In some embodiments, the computer is connected simultaneously with multiple networks (e.g., a Local Area Network and the Internet). In one embodiment, connectivity with a particular network (e.g., the Internet) or with a subset of the available networks is suspended during pestware removal. In another embodiment, all network activity on the computer is suspended during pestware removal.

In some embodiments, network connectivity is automatically suspended as a matter of course before pestware removal is carried out. In other embodiments, network connectivity is automatically suspended based on information that the detected pestware is a particular type of pestware that has a tendency to download pestware when an attempt is made to remove it from a computer. Such information about the characteristics and behavior of various types of pestware can be stored and accessed by an anti-pestware system as needed.

Automatic suspension of network connectivity can be indefinite (e.g., until a system reboot occurs) or temporary, depending on the embodiment. In one illustrative embodiment, network connectivity is restored automatically after the pestware has been removed from the computer. Automatic suspension and restoration of network connectivity (e.g., under software control) obviates the need to disconnect a physical cable from the computer and reconnect it.

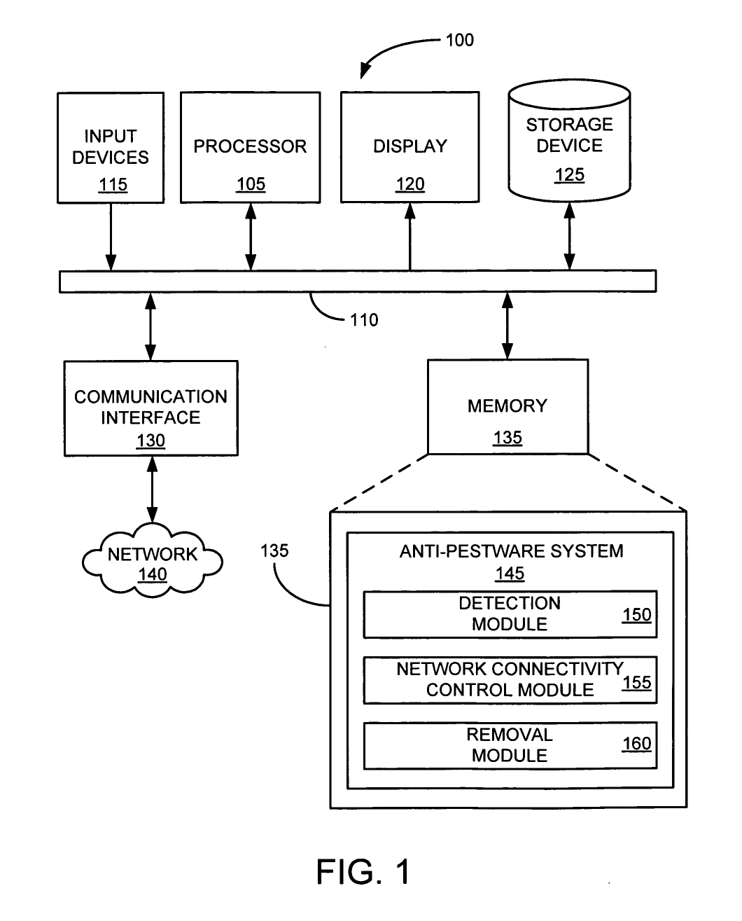

Referring now to the drawings, where like or similar elements are designated with identical reference numerals throughout the several views, and referring in particular to FIG. 1, it is a functional block diagram of a computer 100 equipped with an anti-pestware system in accordance with an illustrative embodiment of the invention. Computer 100 can be a desktop computer, workstation, laptop computer, notebook computer, handheld computer, or any other device that includes computing functionality. In FIG. 1, processor 105 communicates over data bus 110 with input devices 115, display 120, storage device 125, communication interface 130, and memory 135.

Input devices 115 can be, for example, a keyboard and a mouse or other pointing device. In an illustrative embodiment, storage device 125 is a magnetic-disk device such as a hard disk drive (HDD). In other embodiments, however, storage device 125 can be any type of computer storage device, including, without limitation, a magnetic-disk drive, an optical-disc drive, and a storage device employing flash-memory-based media such as secure digital (SD) cards or multi-media cards (MMCs). Communication interface 130 connects computer 100 to network 140. Memory 135 may include random-access memory (RAM), read-only memory (ROM), or a combination thereof.

In FIG. 1, memory 135 includes anti-pestware system 145. Anti-pestware system 145 protects computer 100 against pestware by detecting it and, when appropriate, removing it from computer 100. In the illustrative embodiment of FIG. 1, anti-pestware system 145 is an application program stored on a computer-readable storage medium of computer 100 that can be loaded into memory 135 and executed by processor 105. The computer-readable storage medium can be, for example, a magnetic disk, an optical disc, a solid-state storage medium, or other suitable storage medium. In other embodiments, the functionality of anti-pestware system 145 can be implemented in software, firmware, hardware, or any combination thereof.

For convenience in this Detailed Description, the functionality of anti-pestware system 145 has been divided into three modules: detection module 150, network connectivity control module 155, and removal module 160. In various embodiments of the invention, the functionality of these modules may be combined or subdivided in ways other than that indicated in FIG. 1.

Detection module 150 is configured to scan computer 100 (e.g., running processes in memory 135 and files stored on storage device 125) to detect pestware. Detection module 150 can employ any of a wide variety of pestware detection techniques. For example, detection module 150 can detect a particular type of pestware through the use of “signatures” or “definitions,” characteristics that uniquely identify a particular variety of pestware. In some embodiments, detection module 150 employs a combination of pestware detection techniques. Optionally, detection module 150 may store and access specific information about the behavior of particular types of pestware. For example, the stored information may indicate that a particular type of pestware downloads pestware from the Internet when an attempt is made to remove the pestware from a computer.

Network connectivity control module 155 is configured to suspend the connectivity of computer 100 with network 140 (e.g., the Internet) automatically before detected pestware is removed from computer 100. That is, network connectivity control module 155 is configured to disconnect computer 100 from network 140 automatically before pestware removal begins. Network connectivity control module 155 unconditionally suspends network connectivity before pestware removal in some embodiments. In other embodiments, network connectivity control module 155 suspends network connectivity in response to the need to remove a particular type of pestware that detection module 150 has determined has a tendency to download pestware when an attempt is made to remove it from a computer. Network connectivity control module 155 is configured, in some embodiments, to suspend connectivity with network 140 indefinitely (e.g., until computer 100 is restarted). In another illustrative embodiment, network connectivity control module 155 is configured to restore the connectivity of computer 100 with network 140 automatically after the detected pestware has been removed. Where computer 100 is connected with multiple networks simultaneously, network connectivity control module 155 can be configured, depending on the embodiment, to suspend the connectivity of computer 100 with a subset of the networks or with all of the networks.

Those skilled in the art will recognize that there are a variety of ways in which network connectivity control module 155 can automatically suspend the connectivity of computer 100 with network 140. In one embodiment, a hardware switch (e.g., a relay) that can be controlled through software by network connectivity control module 155 is placed between network 140 and communication interface 130. In other embodiments, network connectivity is controlled entirely through software. For example, a firewall or zone alarm application may be used to suspend network connectivity without the need to disconnect a cable from communication interface 130 manually. Alternatively, application program interfaces (APIs) associated with the operating system of computer 100 can also be used to suspend or restore network connectivity automatically. In one embodiment, network connectivity control module 155 accesses these operating system functions through a network settings control panel or similar user interface.

Removal module 160 is configured to remove pestware detected on computer 100 while the connectivity of computer 100 with network 140 is suspended. In removing pestware from computer 100, removal module 160 may use a variety of techniques, including techniques for deleting “locked” pestware files (files protected against deletion by the operating system). Removal of pestware from computer 100 can include, for example, terminating running pestware processes and deleting pestware files from storage device 125.

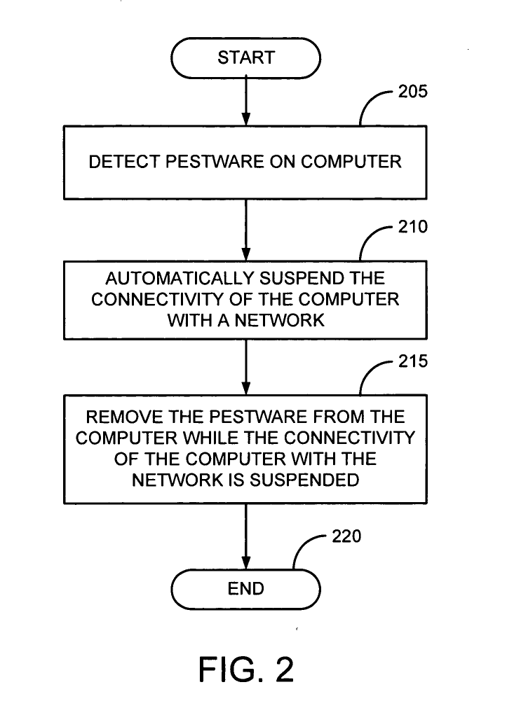

FIG. 2 is a flowchart of a method for removing pestware from a computer in accordance with an illustrative embodiment of the invention. At 205, detection module 150 detects that a particular type of pestware is present on computer 100. At 210, network connectivity control module 155 automatically suspends the connectivity of computer 100 with network 140. At 215, removal module 160 removes from computer 100 the particular type of pestware detected at 205 while the connectivity of computer 100 with network 140 is suspended. The process terminates at 220.

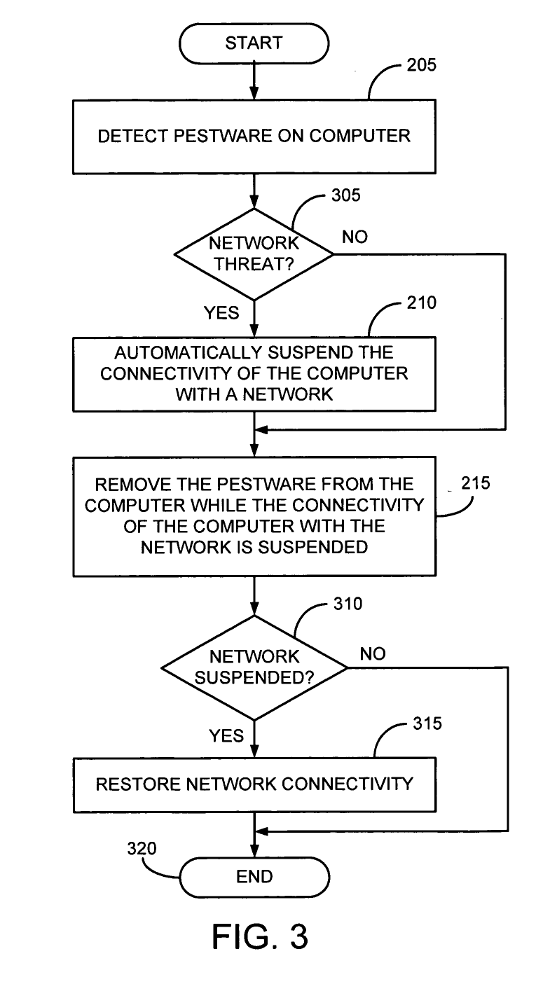

FIG. 3 is a flowchart of a method for removing pestware from a computer in accordance with another illustrative embodiment of the invention. Block 205 is first performed as described in connection with FIG. 2. At 305, detection module 150 determines, based on available information about the particular type of pestware detected at 205, whether the particular type of pestware downloads additional pestware when an attempt is made to delete it. If so, Block 210 is performed as explained in connection with FIG. 2. Otherwise, the process skips to Block 215, which is carried out as explained in connection with FIG. 2. If network connectivity is suspended at 310, network connectivity control module 155 automatically restores the connectivity of computer 100 with network 140 at 315. The process then terminates at 320.

In conclusion, the present invention provides, among other things, a method and system for removing pestware that downloads pestware in response to a removal attempt. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. For example, the principles of the invention can be applied to a variety of operating systems and networks and to a variety of pestware detection and removal techniques.

What is claimed is:

1. A method for removing pestware from a computer, the method comprising:
detecting that pestware is present on the computer;
ascertaining that the pestware is a particular type of pestware that has a tendency to download pestware from a network when an attempt is made to remove the particular type of pestware from a computer;
automatically suspending connectivity of the computer with the network in response to detection of the particular type of pestware;
removing the particular type of pestware from the computer while the connectivity of the computer with the network is suspended; and
automatically restoring the connectivity of the computer with the network after the particular type of pestware has been removed from the computer.

2. A method for removing pestware from a computer, the method comprising:
detecting that pestware is present on the computer;
automatically suspending connectivity of the computer with a network; and
removing the pestware from the computer while the connectivity of the computer with the network is suspended.

3. The method of claim 2, wherein the connectivity of the computer with the network is suspended automatically based on information that the pestware is a particular type of pestware that has a tendency to download pestware from the network when an attempt is made to remove the particular type of pestware from a computer.

4. The method of claim 2, wherein the connectivity of the computer with the network is suspended temporarily, the connectivity of the computer with the network being restored automatically after the pestware has been removed from the computer.

5. The method of claim 2, wherein the network is the Internet.

6. The method of claim 2, wherein all network activity on the computer is suspended automatically before the pestware is removed from the computer.

7. A system for protecting a computer from pestware, the system comprising:
a detection module configured to:
detect that pestware is present on the computer; and
ascertain that the pestware is a particular type of pestware that has a tendency to download pestware from a network when an attempt is made to remove the particular type of pestware from a computer;
a network connectivity control module configured to suspend connectivity of the computer with the network automatically in response to detection of the particular type of pestware; and
a removal module configured to remove the particular type of pestware from the computer while the connectivity of the computer with the network is suspended;
wherein the network connectivity control module is further configured to restore the connectivity of the computer with the network automatically after the particular type of pestware has been removed from the computer.

8. A system for protecting a computer from pestware, the system comprising:
a detection module configured to detect that pestware is present on the computer;
a network connectivity control module configured to suspend connectivity of the computer with a network automatically when the detection module has detected that pestware is present on the computer; and
a removal module configured to remove the pestware from the computer while the connectivity of the computer with the network is suspended.

9. The system of claim 8, wherein the network connectivity control module is configured to suspend the connectivity of the computer with the network automatically based on information that the detected pestware is a particular type of pestware that has a tendency to download pestware from the network when an attempt is made to remove the particular type of pestware from a computer.

10. The system of claim 8, wherein the network connectivity control module is further configured to restore the connectivity of the computer with the network automatically after the removal module has removed the pestware from the computer.

11. The system of claim 8, wherein the network is the Internet.

12. The system of claim 8, wherein the network connectivity control module is configured to suspend all network activity on the computer automatically before the removal module removes the pestware from the computer.

13. A system for protecting a computer from pestware, the system comprising:
means for detecting that pestware is present on the computer;
means for automatically suspending connectivity of the computer with a network when pestware has been detected on the computer; and
means for removing the pestware from the computer while the connectivity of the computer with the network is suspended.

14. The system of claim 13, wherein the means for suspending is configured to suspend the connectivity of the computer with the network automatically based on information that the detected pestware is a particular type of pestware that has a tendency to download pestware from the network when an attempt is made to remove the particular type of pestware from a computer.

15. The system of claim 13, wherein the means for suspending is further configured to restore the connectivity of the computer with the network automatically after the pestware has been removed from the computer.

16. The system of claim 13, wherein the network is the Internet.

17. The system of claim 13, wherein the means for suspending is configured to suspend all network activity on the computer automatically before the pestware is removed from the computer.

18. A computer-readable storage medium containing program instructions executable by a processor to remove pestware from a computer, the program instructions comprising:
a first instruction segment configured to detect that pestware is present on the computer;
a second instruction segment configured to suspend connectivity of the computer with a network automatically when the first instruction segment has detected that pestware is present on the computer; and
a third instruction segment configured to remove the pestware from the computer while the connectivity of the computer with the network is suspended.

19. The computer-readable storage medium of claim 18, wherein the second instruction segment is configured to suspend the connectivity of the computer with the network automatically based on information that the detected pestware is a particular type of pestware that has a tendency to download pestware from the network when an attempt is made to remove the particular type of pestware from a computer.

20. The computer-readable storage medium of claim 18, wherein the second instruction segment is further configured to restore the connectivity of the computer with the network automatically after the third instruction segment has removed the pestware from the computer.

21. The computer-readable storage medium of claim 18, wherein the network is the Internet.

22. The computer-readable storage medium of claim 18, wherein the second instruction segment is configured to suspend all network activity on the computer automatically before the third instruction segment removes the pestware from the computer.
